(19) United States
(12) Patent Application Publication
(10) Pub. No.: US 2017/0275717 A1
(43) Pub. Date: Sep. 28, 2017

(54) EXPLOSIVE HARDENING OF TRACK SHOES

(71) Applicant: BRADKEN RESOURCES PTY LIMITED, Queensland (AU)

(72) Inventors: John Ross SAAD, Queensland (AU); Andrew Gregor DALZIEL, Queensland (AU)

(21) Appl. No.: 15/506,344

(22) PCT Filed: Sep. 8, 2015
(86) PCT No.: PCT/AU2015/050527

§ 371 Date: Feb. 24, 2017

(30) Foreign Application Priority Data
Sep. 8, 2014 (AU) 2014903554

(51) Int. Cl. C21D 7/04; C21D 10/00; B62D 55/20; C21D 9/00

(52) U.S. Cl. CPC C21D 7/04; C21D 9/0087; C21D 10/00; B62D 55/20

(57) ABSTRACT

A component of a crawler type machine is hardened by explosive depth hardening. The component is typically a crawler track shoe (10), and the roller path surface (11) of the track shoe and immediate underlying metal portion are pre-hardened by placing explosive charge (15) on the surface of the track shoe (10), and detonating the explosive charge to impart a high force on the surface and underlying metal portion for a short duration. The resultant shock wave causes high-velocity deformation at a high stress level, which leads to intensive development of plastic displacement at microscopic size. This increases the hardness and the strength of the surface and underlying metal portion. The surface (11) may be hardened by repetitive explosive depth hardening. Grooves (20) may also be formed in the roller path (11) to accommodate any flow of material. Explosive depth hardening can be applied to other surfaces of the track shoe (10), such as the pin bore of a connection lug, or to other components such as a drive tumbler of the crawler.

### TECHNICAL FIELD

The present invention relates to crawler track shoes, such as those used in crawler tracks for mining shovels and other heavy duty equipment. In particular, the invention is directed to an improved method of hardening of the crawler shoes to reduce and/or ameliorate metal flow in the roller path, drive lugs and other wear surfaces of the shoes.

### BACKGROUND ART

Crawler track shoes are usually pivotally connected in a serial manner in an endless loop to form articulated tracks for crawler machines. Descriptions of such track shoes can be found in Australian patents nos. 2003100265 and 2002344704, the disclosures of which are incorporated herein by reference. As such track shoes are known in the art, they need not be described in detail in this specification.

It is known to manufacture crawler track shoes from manganese steel. It has been found that during early stages of operation of a new set of manganese crawler shoes, a significant amount of wear and metal deformation occurs in the roller path and drive lug region of the manganese crawler shoes, as these areas of the shoe are subjected to very high compressive stresses.

The metallurgy of manganese shoes is characterised by high toughness, but initial low tensile strength and low hardness. However, manganese steel material hardens with repeated application thereto of compressive forces during an initial work hardening period. These compressive forces change the material microstructure to a certain depth. Within this hardened surface layer, the material more than doubles in hardness, and the strength and wear characteristics increase appreciably. Nevertheless, because the material is relatively soft initially, a significant amount of metal flow occurs. This results in loss of wear material and increased stresses on the crawler shoes, which can lead to failure of the shoes.

Known manganese shoes do not attempt to eliminate the initial metal flow but rather are designed with extra metal to compensate for the early wear which occurs prior to, or during, work hardening. This increased material adds to the cost of manufacturing the shoes, and complexity of design.

It is a preferred aim of the present invention to provide an improved method of hardening crawler shoes, and the resultant hardened shoes, which overcome or ameliorate the abovementioned disadvantage or provide the user with a useful or commercial choice.

### SUMMARY OF INVENTION

In one broad form, the present invention provides a hardening a component of a crawler type machine by explosive depth hardening. In a preferred embodiment, the component is a crawler track shoe, and a roller path surface of the crawler track shoe is hardened.

In one embodiment, the surface and immediate underlying metal portion of a roller path surface of a crawler track shoe are hardened by placing explosive charge on, or adjacent, the surface of the crawler track shoe, and detonating the explosive charge to impart a high force on the surface and underlying metal portion for a short duration. A shock wave arises in the metal as a result of the detonation of the explosive charge, and this causes high-velocity deformation at a high stress level, which leads to intensive development of plastic displacement at microscopic size. This increases the hardness and the strength of the surface and underlying metal portion.

In manganese steel, shock waves of 20 GN/m2 can increase the Brinell hardness from 200-220 to 300-350 and the tensile strength from 6.0 to 10.0 MN/m2.

More information on explosive depth hardening can be found in ‘Explosive hardening of iron and low-carbon steel’, L. A. Potteiger, US Naval Weapons Laboratory Report no. 1950, 14 Oct. 1964, also available at www.dtic.mil/dtic/tr/fulltext/u2/453901.pdf, and ‘Wear of the Railway Turnout Crossings made of Explosive Hardened Hadfield Steel’, Havlicek and Zboril, Metal 2013, May 15-17 2103, Brno, Czech Republic, the disclosures of which are incorporated herein by reference.

Other components of a crawler type machine, such as a connection lug or a pin bore of a track shoe, or a drive tumbler on the crawler's drive mechanism, may also be hardened by explosive depth hardening.

Although explosive depth hardening has been used for hardening railway components, hitherto it has not known or thought suitable for use with crawler track shoes or other components of a crawler type machine.

An advantage of explosive hardening of components of a crawler type machine is that there is only a small change to the dimensions of the hardened components. Another advantage is that the hardening extends a distance below the surface of the hardened components (typically up to 50-100 mm, depending on the strength and height of the charge).

The surface of the component may be hardened by repetitive explosive depth hardening.

Advantageously, the components are ‘pre-hardened’, i.e. before they are put into use.

In another form, the present invention provides crawler track shoes hardened by explosive depth hardening as described above.

Typically, the crawler shoes are made from manganese steel, but the invention may also be applied to crawler shoes made from other suitable material.

Explosive depth hardening imparts the compressive forces and stresses on the steel required to work harden the surface and the subsurface, but without the compressive forces and stresses and consequent metal flow that would occur in initial service. The pre-hardening will not appreciably alter the shape/dimensions of the crawler shoe and will significantly reduce or even eliminate the initial metal flow currently observed in the early stages of prior art manganese shoe operations. Explosive metal hardening increases the wear resistance of the track shoes, and consequently their service life.

Typically, at least the portions subject to most wear are pre-hardened, e.g. the roller path, drive lugs, pin bores and other wear surfaces of track shoes.

In addition to explosive depth hardening, grooves may be formed in the roller path of the track shoe to accommodate any flow of material. These grooves may be parallel in one direction, or ‘cross-hatched’ in orthogonal directions.

By pre-hardening crawler track shoes through explosive depth hardening, the metal flow which is typically observed in prior art shoes does not occur. This results in less machinery downtime to remove any excess metal flow, lower stresses being transferred to the shoe due to the metal flow which could otherwise lead to failure of the shoe, more wear material being retained due to the substantial reduction of the initial metal flow, and hence greater longevity of the crawler shoe.

Any of the features described herein can be combined in any combination with any one or more of the other features described herein within the scope of the invention.

### BRIEF DESCRIPTION OF DRAWINGS

Embodiments of the invention will now be described, by way of example, with reference to the following drawings, in which:

FIG. 1 is a perspective view of a crawler track shoe.

FIG. 2 is a front view of a crawler track shoe having explosive material thereon.

FIG. 3 is a perspective view of the crawler track shoe of FIG. 2.

FIG. 4 is a perspective view of a track shoe having a grooved roller path.

FIG. 5 is a front view of the track shoe of FIG. 4.

### DESCRIPTION OF EMBODIMENTS

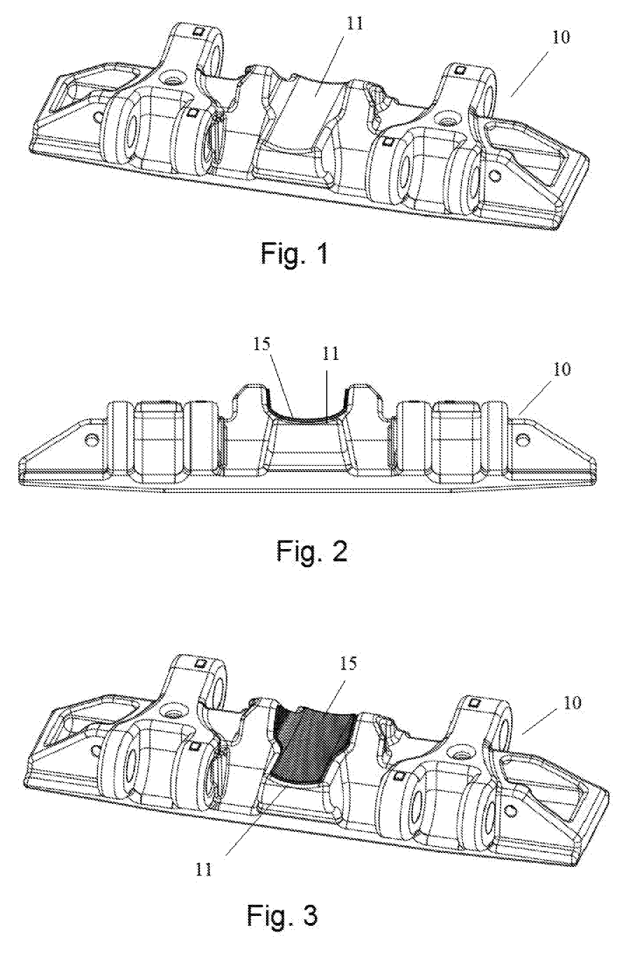

FIG. 1 illustrates a track shoe 10 of the type used to form articulated tracks for crawler machines. Descriptions of such track shoes can be found in Australian patents nos. 2003100265 and 2002344704.

The track shoe 10 comprises a body having leading and trailing lugs for pin connection to similar track shoes to form a crawler track, as is known in the art. The track shoe 10 is typically made of cast steel, and preferably manganese steel.

The track shoe 10 has a roller path surface 11, upon which a roller of the crawler machine travels. The roller paths 11 of the track shoes therefore bear the weight of the crawler machine, and are subjected to very high compressive stresses. The load bearing surfaces of track shoes are prone to metal flow, particularly during initial operations before the surfaces become work hardened.

To alleviate this problem, at least the surface portion of the roller path 11 is pre-hardened by explosive depth hardening before the track shoe 10 is put into service. The ‘surface portion’ refers to the portion of the roller path adjacent to the upper surface of the roller path, and typically extends to a depth of the order of 25 mm, but may be as much as 100 mm depending on the application.

As shown in FIGS. 2 and 3, a layer of explosive charge 15 is laid over the roller path 11. This explosive charge 15 is then ignited or exploded in controlled circumstances. The explosion imparts high compressive forces on the surface of the roller path 11, which work hardens the roller path surface and subsurface, i.e. the portion immediately below the surface.

The explosive charge 15 may be covered or shielded by a shock resistant cover or layer on the side opposite to the track shoe, to direct more of the explosive force onto the track shoe.

The roller path surface may be subjected to a single explosion, or a series of explosives. The pre-hardening of the surface portion will not appreciably alter the shape and dimensions of the crawler shoe. However, the hardened roller path surface will significantly reduce or even eliminate the initial metal flow which is currently observed in the early operating stages of track shoes, particularly those made of manganese steel.

In one embodiment of the explosive depth hardening process of the present invention, explosive materials are applied directly to the surface of cast austenitic manganese steel track shoes to be hardened, (after appropriate solution annealing), and are detonated, directing the resultant explosive forces into the surface. The process works the treated cast surface, with the hardening effects increasing in magnitude and depth through subsequent applications of the explosive depth hardening process.

Although the invention has been described with particular reference to hardening of surface portions of the roller path 11, the invention can also be applied to other paths of the track shoe and/or the crawler machine, such as the pin bores of the leading and trailing lugs of the track shoe, and the drive tumblers of the machine.

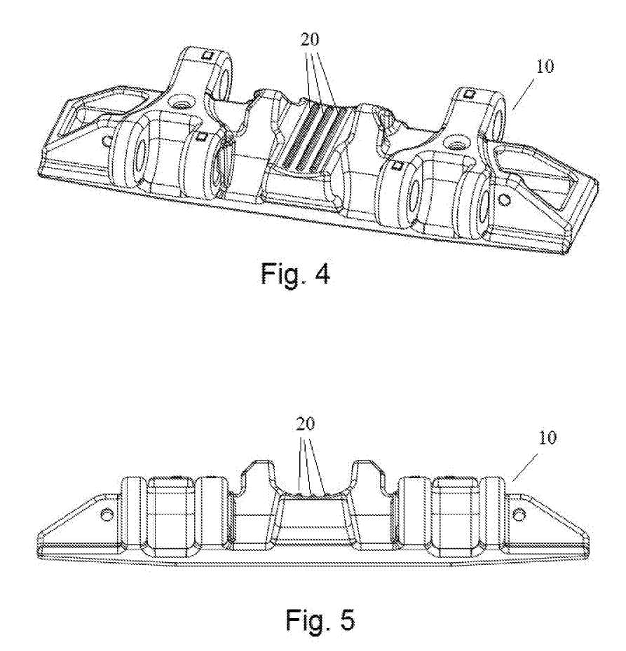

Advantageously, as shown in FIGS. 4 and 5, grooves 20 are also formed in the roller path 11, either before or after the explosive depth hardening of the roller path. Ridges are also typically formed adjacent the grooves. During initial metal flow, the material will flow into the adjacent grooves.

The grooves 20 are preferably parallel in the direction of travel of the roller along the roller path. Alternatively, the grooves may be transversed to the direction of travel along the roller path. Preferably however, the grooves are formed in a ‘cross hatch’ pattern, extending both parallel and transverse to the direction of travel of the roller along the roller path. Other suitable groove patterns can also be utilised.

The groves are optional, and the explosive depth hardening can be used on a smooth roller path (that is no ridges) and also on track shoes that do have ridges.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

Reference to background art or other prior art herein is for explanatory purposes only, and does not constitute an admission that such background art or other prior art forms part of the common general knowledge in the art in any country.

1. A method of hardening a component of a crawler type machine, characterized in that a surface of the component is hardened by explosive depth hardening.

2. A method as claimed in claim 1 wherein the component is a crawler track shoe.

3. A method as claimed in claim 2 wherein a roller path surface of the crawler track shoe is hardened.

4. A method as claimed in claim 3, further comprising the step of forming grooves in the roller path surface to accommodate flow of material under pressure.

5. A method as claimed in claim 4, wherein the grooves are parallel in one direction, or ‘cross-hatched’ in orthogonal directions.

6. A method as claimed in claim 2, wherein the surface of the crawler track shoe which is hardened is a surface of a connection lug or a pin bore of the track shoe.

7. A method as claimed in claim 1 wherein the component is a drive tumbler of the crawler type machine.

8. A method as claimed in any preceding claim, wherein the surface is hardened before the component is put in use.

9. A method as claimed in claim 1, wherein the surface is hardened by placing explosive charge on or adjacent the surface and detonating the explosive charge to impart a high force on the surface and underlying metal portion for a short duration.

10. A method as claimed in claim 1, wherein the surface is hardened by repetitive explosive depth hardening.

11. A component for a crawler type machine, characterized in that a surface of the component has been hardened by explosive depth hardening.

12. A component for a crawler type machine as claimed in claim 11, wherein the component is a crawler track shoe.

13. A component for a crawler type machine as claimed in claim 12, wherein the surface is a roller path surface of the crawler track shoe.

15. A component for a crawler type machine as claimed in claim 14, wherein the roller path surface has grooves therein to accommodate flow of material under pressure.

16. A component for a crawler type machine as claimed in claim 12, wherein the surface of the crawler track shoe which is hardened is a surface of a connection lug or a pin bore of the track shoe.

17. A component for a crawler type machine as claimed in claim 12, wherein the crawler track shoe is made from manganese steel.

18. A component for a crawler type machine as claimed in claim 11, wherein the component is a drive tumbler of the crawler type machine.

19. A component for a crawler type machine as claimed in claim 11, wherein the surface has been hardened by placing explosive charge on or adjacent the surface and detonating the explosive charge to impart a high force on the surface and underlying metal portion for a short duration.

20. A component for a crawler type machine as claimed in claim 11, wherein the surface has been hardened by repetitive explosive depth hardening.
